(19) United States
(12) Patent Application Publication
(10) Pub. No.: US 2022/0288807 A1
(43) Pub. Date: Sep. 15, 2022

(54) ERGONOMIC NAIL GUN PLATFORM AND SYSTEM

(71) Applicant: Andrew T SAGE, Ames, IA (US)

(72) Inventor: Andrew T SAGE, Ames, IA (US)

(21) Appl. No.: 17/690,068

(22) Filed: Mar. 9, 2022

Related U.S. Application Data
(60) Provisional application No. 63/159,905, filed on Mar. 11, 2021.

(51) Int. Cl. B27F 7/09; E04F 21/22

(52) U.S. Cl. CPC B27F 7/09; E04F 21/22

(57) ABSTRACT

An ergonomic nail gun system is disclosed having a carriage assembly with a first set of wheels constraining the platform to move in a linear direction when resting on a panel. The system has a transverse movement assembly including a second set of wheels is configured to guide system in a second direction that is transverse to the first direction when system is tilted onto the second set of wheels. The system has a nail gun assembly is movable between a plurality of positions including a tilted position and a non-tilted position. When in the tilted position, the nail gun assembly is configured to drive the nails into the floor at an angle. The system includes a handle positioned to facilitate operation of the system from a standing position. The nail gun is triggered by depressing two safety interlock switches on the handle to prevent accidental firing.

### CROSS REFERENCE TO RELATED APPLICATIONS

This application claims priority to U.S. Provisional Patent Application No. 63/159,905 filed Mar. 11, 2021 and titled ERGONOMIC NAIL GUN PLATFORM AND SYSTEM, which is hereby incorporated by reference herein in its entirety, including any figures, tables, or drawings or other information.

### OVERVIEW

Nail guns, have revolutionized construction methods and this is especially evident when installing flooring. Although using a nail gun is a great improvement over using a manual hammer and nail, traditional nail guns require the operator to kneel on the flooring to be installed. This is difficult to do for a long period of time and requires the user to move along the flooring since the range of motion is limited by the arm length of the user.

For the reasons stated above, and for other reasons stated below which will become apparent to those skilled in the art upon reading and understanding the disclosure, there is a need for an ergonomic nail gun platform and system that allows a user to stand up while using the nail gun. Additionally, it is important that the operator be able to move the nail gun in regular and orthogonal patterns while nailing without the need to manually correct the position.

Thus, it is an object of the disclosure to provide an ergonomic nail gun platform and system that improves upon the state of the art.

Another object of the disclosure is to provide an ergonomic nail gun platform and system that is easy to use.

Yet another object of the disclosure is to provide an ergonomic nail gun platform and system that is fast and efficient to use.

Another object of the disclosure is to provide an ergonomic nail gun platform and system that is portable.

Yet another object of the disclosure is to provide an ergonomic nail gun platform and system that is cost effective.

Another object of the disclosure is to provide an ergonomic nail gun platform and system that drives nails vertically and at an angle.

Yet another object of the disclosure is to provide an ergonomic nail gun platform and system that can be moved linearly forward and backward as well as transversely to the side.

Another object of the disclosure is to provide an ergonomic nail gun platform and system that can be moved and operated from a standing position.

Yet another object of the disclosure is to provide an ergonomic nail gun platform and system that has a long useful life.

Another object of the disclosure is to provide an ergonomic nail gun platform and system that has a durable design.

Yet another object of the disclosure is to provide an ergonomic nail gun platform and system that has a wide variety of applications.

Another object of the disclosure is to provide an ergonomic nail gun platform and system that improves the ergonomics of use.

These and other objects, features, or advantages of at least one embodiment will become apparent from the specification, figures, and claims.

### SUMMARY

In one or more arrangements, an ergonomic nail gun system is presented. In one or more arrangement, the system includes a carriage assembly, a transverse movement assembly and a nail gun assembly. The nail gun assembly is configured to drive nails into a floor to facilitate installation of flooring. The carriage assembly includes a first set of wheels configured to guide system in a first linear direction on the floor to facilitate driving of the nails along a straight line. The transverse movement assembly including a second set of wheels configured to guide system in a second direction that is transverse to the first direction. The transverse movement assembly is movable between a first orientation and a second orientation. When the transverse movement assembly is in the first orientation, the first set of wheels are placed in contact with the floor and the second set of wheels are raised above the floor, thereby permitting movement of the system in the first direction. When the transverse movement assembly is in the second orientation, the second set of wheels are placed in contact with the floor and the first set of wheels are raised above the floor, thereby permitting movement of the system in the second direction.

In one or more arrangements, the transverse movement assembly is in the second orientation, the system is tilted backward at an angle onto the second set of wheels. In one or more arrangements, the system includes a handle operably connected to the carriage assembly. The handle configured to facilitate movement and operation of the system by a user in a standing position. In one or more arrangements, moving an upper end of the handle downward and rearward by the user causes the transverse movement assembly to be placed in the second orientation, thereby permitting movement of the system in the second direction.

In one or more arrangements, a control assembly is operably connected to an upper end of the handle. The control assembly is configured to trigger nailing of nails by the nail gun assembly. In one or more arrangements, the control assembly includes a first switch and a second switch and the control assembly is configured to only trigger nailing of the nails by the nail gun assembly when both the first switch and the second switch are engaged by the user.

In one or more arrangements, the nail gun assembly is movable between a plurality of positions including a tilted position and a non-tilted position. When in the tilted position, the nail gun assembly is configured to drive the nails into the floor at an angle to facilitate angle of the flooring. In one or more arrangement, the system includes a tilt control assembly. The tilt control assembly includes an actuator configured to be movable between a first position and a second position. When the actuator is in the first position, tilt control assembly is configured to hold the nail gun assembly at one of the plurality of positions. When the actuator is in the second position, tilt control assembly is configured to permit the nail gun assembly to be moved between the plurality of positions.

In one or more arrangements, the system includes a recoil assembly. The recoil assembly operably connects the nail gun assembly to the carriage assembly and is configured to permit nail gun assembly to recoil when a nail is driven to inhibit unintended movement of system.

In one or more arrangements, the system includes an air tank reservoir for use with a pneumatic nail gun powered by an air compressor. The air tank reservoir is fluidically connected to the pneumatic nail gun and to the compressor and help to mitigate drops in pressure resulting from use of the nail gun.

Other features and advantages of the instant invention will become apparent from the following description of the invention which refers to the accompanying drawings.

### BRIEF DESCRIPTION OF THE DRAWINGS

FIG. 1 shows a bottom view of an ergonomic nail gun platform and system, in accordance with one or more embodiments.

FIG. 2 shows a left side view of the ergonomic nail gun platform and system shown in FIG. 1, in accordance with one or more embodiments.

FIG. 3 shows a close up view of the portion shown in FIG. 2, in accordance with one or more embodiments

FIG. 4 shows a close up front view of the lower end of the ergonomic nail gun platform and system shown in FIG. 1, in accordance with one or more embodiments.

FIG. 5 shows a right side view of an ergonomic nail gun platform and system, in accordance with one or more embodiments; the view showing linear movement using the ergonomic nail gun platform and system.

FIG. 6 shows a right side view of an ergonomic nail gun platform and system, in accordance with one or more embodiments; the view showing transverse movement using the ergonomic nail gun platform and system.

FIG. 7 is partial rear view of ergonomic nail gun platform and system shown in FIG. 1, in accordance with one or more embodiments.

FIG. 8 is a detailed view of a portion shown in FIG. 1, in accordance with one or more embodiments.

FIG. 9 is a detailed view of a portion shown in FIG. 1, in accordance with one or more embodiments.

FIG. 10 shows an upper front right perspective view of an ergonomic nail gun platform and system, in accordance with one or more embodiments.

FIG. 11 shows an exploded upper front right perspective view of the ergonomic nail gun platform and system shown in FIG. 10, in accordance with one or more embodiments.

FIG. 12 shows an exploded upper front right perspective view of the carriage assembly for the ergonomic nail gun platform and system shown in FIG. 10, in accordance with one or more embodiments.

FIG. 13 shows an exploded upper front right perspective view of the nail gun assembly for the ergonomic nail gun platform and system shown in FIG. 10, in accordance with one or more embodiments.

FIG. 14 shows a left side view of the ergonomic nail gun platform and system shown in FIG. 10, in accordance with one or more embodiments.

FIG. 15 shows a right side view of the ergonomic nail gun platform and system shown in FIG. 10, in accordance with one or more embodiments.

FIG. 16 shows a front view of the ergonomic nail gun platform and system shown in FIG. 10, in accordance with one or more embodiments.

FIG. 17 shows a rear view of the ergonomic nail gun platform and system shown in FIG. 10, in accordance with one or more embodiments.

FIG. 18 shows a top view of the ergonomic nail gun platform and system shown in FIG. 10, in accordance with one or more embodiments.

FIG. 19 shows a bottom view of the ergonomic nail gun platform and system shown in FIG. 10, in accordance with one or more embodiments.

FIG. 20A shows a front view of an ergonomic nail gun platform and system, in accordance with one or more embodiments.

FIG. 20B shows a close up view of the nail gun tracking wheel shown in FIG. 20A, in accordance with one or more embodiments.

FIG. 21A shows a rear view of an ergonomic nail gun platform and system shown in FIG. 10, in accordance with one or more embodiments; the view showing the ergonomic nail gun platform and system tilted up on the transverse tracking wheels.

FIG. 21B shows a right side view of an ergonomic nail gun platform and system shown in FIG. 10, in accordance with one or more embodiments; the view showing the ergonomic nail gun platform and system tilted up on the transverse tracking wheels.

FIG. 22 shows an upper side front perspective view of a tracking wheel for use in an ergonomic nail gun platform and system, in accordance with one or more embodiments.

FIG. 23 shows an front view of a tracking wheel for use in an ergonomic nail gun platform and system, in accordance with one or more embodiments.

FIG. 24 shows an close up view of the portion shown in FIG. 23, in accordance with one or more embodiments

FIG. 25 shows an upper front right perspective view of a control assembly for an ergonomic nail gun platform and system, in accordance with one or more embodiments.

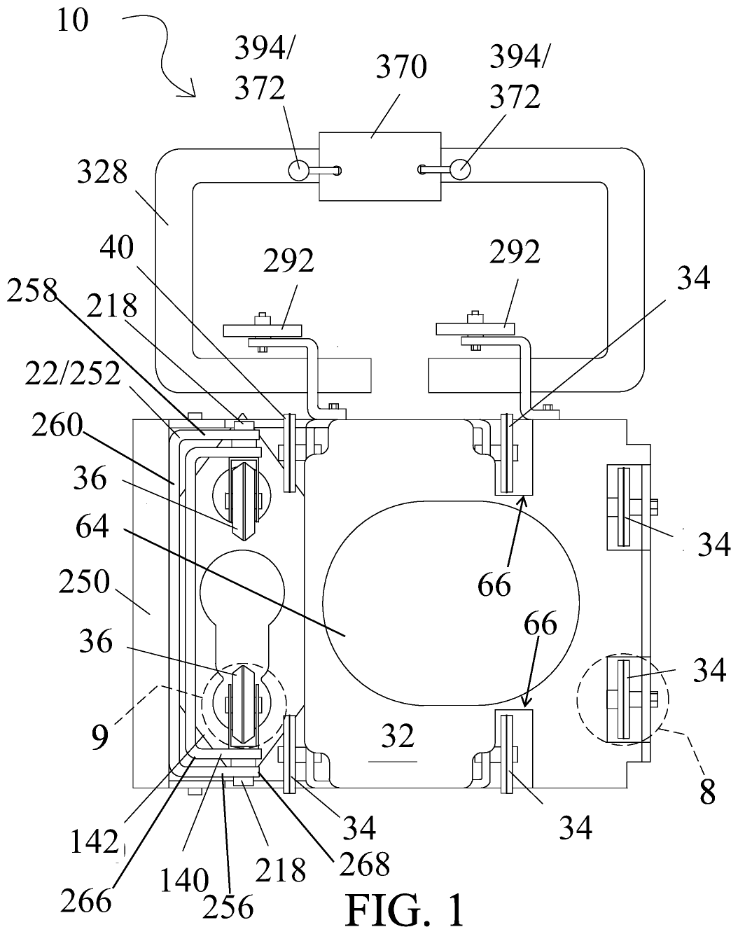

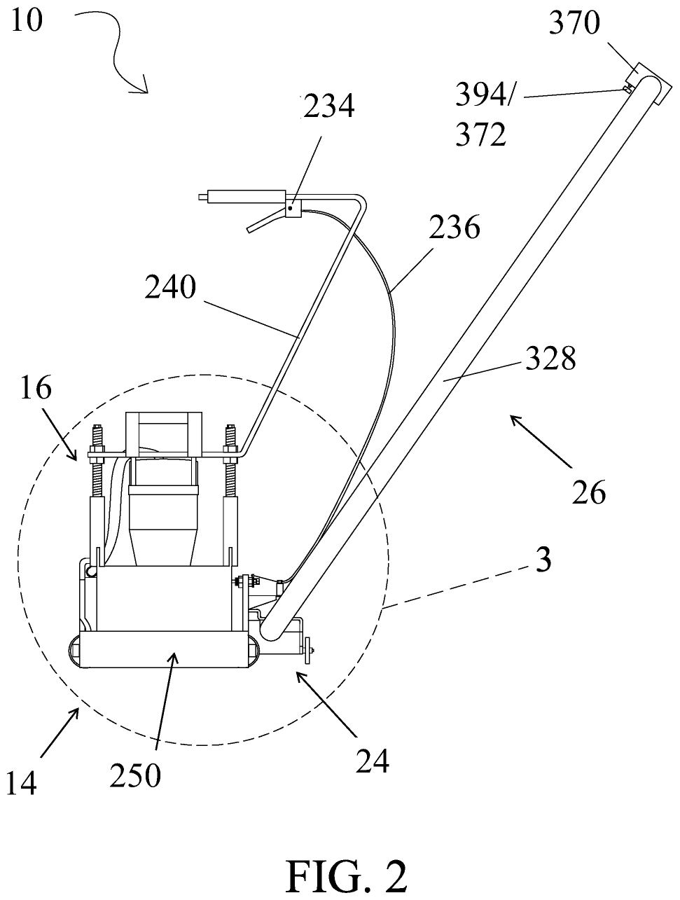

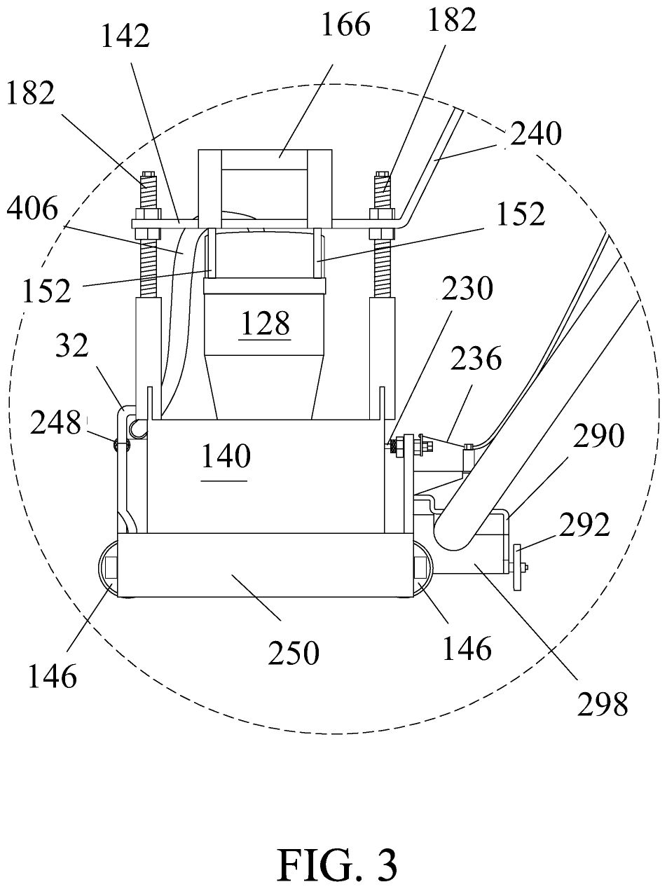

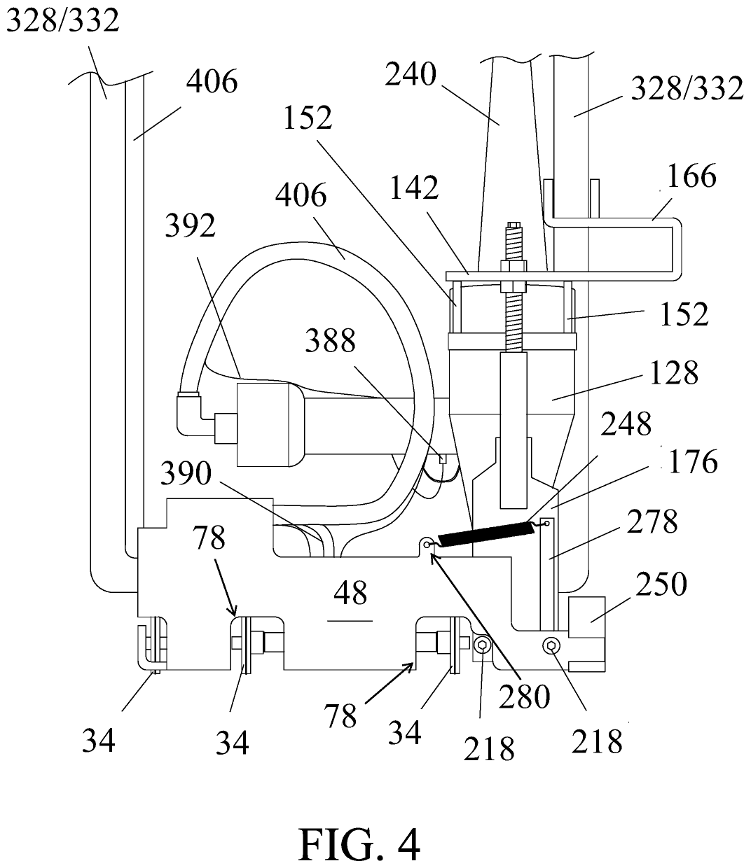

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of a nail gun system for installation of flooring. However, the embodiments are not so limited. It is appreciated that the embodiments may be adapted for use in other applications which may be improved by the disclosed structures, arrangements and/or methods. The system is merely shown and described as being used in the context of context a nail gun system for installation of flooring for ease of description and as one of countless examples.

### System 10:

Referring to figures an ergonomic nail gun system 10 (or system 10 or platform 10) is shown having a frame 32, which forms the framework that supports the system. In the arrangement shown, as one example system 10 includes a carriage assembly 14, a nail gun assembly 16, a recoil assembly 22, a transverse movement assembly 24, and a handle assembly 26 among other components.

### Carriage Assembly 14:

Carriage assembly 14 is formed of any suitable size, shape, or design and is configured to interconnect components of system 10 and facilitate movement of system 10 forward and backward in a linear direction 40. In the arrangement shown, as one example carriage assembly includes a frame 32, tracking wheels 34 among other components.

### Frame 32:

Frame 32 is formed of any suitable size, shape, or design and is configured to interconnect tracking wheels 34 and other components of system 10.

In the arrangement shown as one example, frame 32 include a bottom 46, a front flange 48, a rear flange 50, and a side flange 52 among other components.

In the arrangement shown, as one example, bottom 46 has a planar generally rectangular shape extending between a front edge 56, a rear edge 58, a left edge 60, and a right edge 62. In this example arrangement, bottom 46 has an opening 64 to facilitate access to components of system and reduce weight. In this example arrangement, bottom 46 has generally rectangular shaped cutaways 66 proximate to the front edge 56 and rear edge 58 to accommodate positioning of linear tracking wheels 34.

In the arrangement shown, as one example, front flange 48 extends upward from front edge 56 of bottom 46. In this example arrangement, front flange 48 has a generally rectangularly planar shaped main body extending between a lower edge 70, an upper edge 72, a left edge 74, and a right edge 76. In this example arrangement, front flange has generally rectangular shaped cutaways 78 extending upward from lower edge 70 to accommodate positioning of linear tracking wheels 34.

In this example arrangement, front flange 48 includes tabs 80 extending rearward from cutaways 78 to accommodate connection with linear tracking wheels 34. In this example arrangement, front flange 48 also includes a tab 82 extending upward from upper edge 72 to facilitate connection with a recoil spring 248 of recoil assembly 22. In this example arrangement, front flange 48 also includes a tab 84 extending leftward from left edge 74. In this example, rear flange 50 similarly also includes a tab 100 extending leftward from left edge 94. Tabs 84 and 100 are configured to facilitate connection of frame 32 with nail gun tilt assembly 130, and recoil assembly 22 among other components.

In the arrangement shown, as one example, rear flange 50 extends upward from front edge 56 of bottom 46. In this example arrangement, rear flange 50 has a generally rectangularly planar shaped main body extending between a lower edge 90, an upper edge 92, a left edge 94, and a right edge 96. In this example arrangement, rear flange 50 has generally rectangular shaped cutaways 98 extending upward from lower edge 90 to accommodate positioning of linear tracking wheels 34. In this example arrangement, rear flange 50 includes tabs 102 extending forward from cutaways 98 to accommodate connection with linear tracking wheels 34.

In the arrangement shown, as one example, side flange 52 extends upward from right edge 62 of bottom 46. In this example arrangement, side flange 52 has a generally rectangularly planar shape a lower edge 70, an upper edge 72, a left edge 74, and a right edge 76.

In this example arrangement, holes 114 are formed in flanges 48, 50, and 52 and/or tabs 80, 82, and 84 to facilitate connection with linear tracking wheels 34, recoil spring 248, nail gun tilt assembly 130, recoil assembly 22 and/or other components with frame 32 (e.g., using bolts). However, the arrangements are not so limited. Rather, it is contemplated that various components of system 10 may be connected using various means and methods known in the art including but not limited to, for example, adhesive bonding, chemical bonding, welding, and/or mechanical attachment means such as screws, bolts, threading, interlocks, clips, pins, or other coupling devices.

### Tracking Wheels 34:

Tracking wheels 34 are formed of any suitable size, shape, or design and are configured to facilitate movement of carriage assembly 14 forward and backward in a linear direction 40. In the arrangement shown, as one example, tracking wheels 34 have a generally circular disc shape with a cylindrical tube shaped collar 122 extending through a center of the tracking wheels 34. In the arrangement shown, tracking wheels 34 are attached to frame 32 using brackets and/or bolts 124 that extend through collars 122 and hold tracking wheels 34 in a stable position while providing smooth rotation of tracking wheels 34. However, the embodiments are not so limited. Rather, it is contemplated that various components of system 10 may be connected using various means and methods known in the art including but not limited to, for example, adhesive bonding, chemical bonding, welding, and/or mechanical attachment means such as screws, bolts, threading, interlocks, clips, pins, or other coupling devices that provide for rotation of tracking wheels 34. In one or more arrangements, tracking wheels 34 may include bearings (not shown) positioned within or forming part of collars 122 to improve rotation of tracking wheels 34.

In the arrangement shown, as one example, linear tracking wheels 34 have a tracking ridge 126 extending around a circumference of the linear tracking wheels 34 that helps system 10 track true as it rolls along linear tracking wheels 34. Tracking ridge 126 may be formed as part of linear tracking wheel 34 or may be a separate material added to the wheel. Tracking ridge may be formed of various materials including but not limited to for example, a rubber ridge, composite material or other suitable material that provides a true tracking and/or inhibit marking of floor panels 422. Tracking ridge could also be a selected geometry such as having the linear tracking wheel come to a sharp V-shaped profile that would function to maintain tracking in a straight line.

In the arrangement shown, carriage assembly 14 includes six linear tracking wheels 34 are attached to frame 32. However, the embodiments are not so limited. Rather, it is contemplated that some various arrangements may be adapted to include any number of linear tracking wheels 34 as long as system 10 moves linearly without shifting.

### Nail Gun Assembly 16:

Nail gun assembly 16 is formed of any suitable size, shape, or design and is configured to drive nails or other fasteners downward to facilitate installation of flooring. In the arrangement shown, as one example, nail gun assembly 16 includes a nail gun 128, and a nail gun tilt assembly 130, among other components.

Some various different arrangement may utilize various different types of nail guns. In an arrangement shown, as one example, nail gun 128 is a pneumatic gun that operates on compressed air. An air coupling is provided (not shown) to connect system 10 to an air compressor (not shown) for operation. An air hose 406 connects from air coupling (not shown) to nail gun 128 as is known in the art. However, the embodiments are not so limited. Rather, it is contemplated that in various different arrangements may use various types of nail guns including but not limited to, for example, pneumatic nail guns, electric nail guns, gas powered nail guns, powder actuated nail guns, or any other type of nail gun that can be mounted within system 10.

Furthermore, although some arrangements may be primarily described with reference to nail guns, the embodiments are not so limited. Rather, it is contemplated that in various different arrangements may use guns for driving various types of fasteners including but not limited to, for example, nails, staples, screws, bolts, anchors, or any other type of fastener.

### Nail Gun Tilt Assembly 130:

Nail gun tilt assembly 130 is formed of any suitable, size, shape, and design and is configured to operably connect nail gun 128 with carriage assembly 14 and facilitate driving nails (or other fastener) vertically as well as at an angle. In the arrangement shown, as one example, nail gun tilt assembly 130 includes a nail gun mounting support frame 140, an adjustable mounting plate 142, tilt control assembly 144, and nail gun tracking wheels 146.

In this example arrangement, nail gun 128 is attached to adjustable mounting plate 142 by bolts 150 that are threaded through cylindrical spacers 152 and inserted into nail gun 128. In order to attach bolts 150 to a nail gun 128 (e.g., a commercial off the shelf nail gun), fasteners provided with nail gun 128 may be removed and replaced with bolts 150. This firmly attaches nail gun 128 to adjustable mounting plate 142. Of course other securing methods may be used, such as, but not exclusively straps, hold-downs or other acceptable methods as long as nail gun 128 is securely held in place to nail gun mounting support frame 140.

Adjustable mounting plate 142 is formed of any suitable size, shape, or design and is configured to connect with nail gun 128 as well as with nail gun mounting support frame 140, so as to connect nail gun 128 with nail gun mounting support frame 140. In the arrangement shown, as one example, adjustable mounting plate 142 has a planar diamond shape extending between opposing side edges 156 from a front end 158 to a rear end 160. In this example arrangement, adjustable mounting plate 142 has a set of holes 162 to facilitate connection with bolts 150 and nail gun 128. In this example arrangement, adjustable mounting plate 142 also has a set of holes 164 to facilitate connection with nail gun mounting support frame 140.

In some arrangements, adjustable mounting plate 142 has a carrying handle 166 to allow the user to lift and position system 10. In the example arrangement shown, carrying handle 166 is formed by a flanges 168 extending upward from one of the side edges 156 and a handhold 170 extending between the flanges 168.

Nail Gun Mounting Support Frame 140:

Nail gun mounting support frame 140 is formed of any suitable size, shape, or design and is configured to operably connect adjustable mounting plate 142 and nail gun 128 with frame 32 and permit nail gun 128 to be tilted at an angled to facilitate angle-nailing. In the arrangement shown, as one example, nail gun mounting support frame 140 includes a lower front member 176, a lower back member 178, a lower side member 180, and threaded connection members 182, among other components.

In this example arrangement, lower front member 176 has an elongated planar shape extending from a lower end 188 to an upper end 190 between a right edge 192 and a left edge 194. Similarly, lower back member 178 has an elongated planar shape extending from a lower end 198 to an upper end 200 between a right edge 202 and a left edge 202. In this example arrangement, lower side member 180 has a planar shape generally rectangular shape extending between a lower edge 208 and an upper edge 210 from left edge 202 of lower back member 178 and left edge 194 of lower front member 176.

In this example arrangement, threaded connection members 182 are operably connected to upper end 200 and upper end 190 and are configured to facilitate connection of nail gun mounting support frame 140 with adjustable mounting plate 142. In the arrangement shown, adjustable mounting plate 142 is connected with threaded connection members with nuts 214 positioned above and below adjustable mounting plate 142. In this example arrangement, adjustable mounting plate 142 and nail gun 128 to be raised and lowered relative to nail gun mounting support frame 140 by moving nuts 214 higher or lower on threaded connection members 182.

In one or more arrangements, nail gun mounting support frame 140 is operably connected to frame 32 of carriage assembly 14 by a hinged connection that permits nail gun 128 to be tilted to an angle, for example, to facilitate angle-nailing. In the arrangement shown, as one example, lower front member 176 and a lower back member 178 of nail gun mounting support frame 140 have holes 216 posited proximate to lower ends 188 and 198 to facilitate such hinged connection. More specifically, in this example arrangement, nail gun mounting support frame 140 is hingedly connected to recoil assembly 22 by carriage pivot bolts 218 that extend through holes 216. In this example arrangement, recoil assembly 22 is also rotatably attached to frame 32 using carriage pivot bolts 218.

### Tilt Control Assembly 144:

Tilt control assembly 144 is formed of any suitable size, shape, or design and is configured to permit a user to move nail gun assembly 16 to and hold nail gun assembly 16 in place at a plurality of different angled positions. In the arrangement shown, as one example, tilt control assembly 144 three tilt adjustment slots (pivot position slot one 224, pivot position slot two 226, and pivot position slot vertical 228) formed in lower back member 178 of nail gun mounting support frame 140. In this example arrangement, tilt control assembly 144 also includes a retractable tilt pin 230 that is connected to frame 32 and is configured to engage slots 224, 226, and 228 and thereby hold nail gun assembly 16 in place at a plurality of different angled positions. In this example arrangement, slots 224, 226, and 228 are positioned to hold nail gun 128 in a vertical position, a position angled to the left, and a position angled to the right, depending on which slot is chosen.

In this example arrangement, tilt control assembly 144 also includes an actuator 234 operably connected to retractable tilt pin 230 using cable 236. When actuator 234 is engaged, retractable tilt pin 230 is retracted from a pivot slot 224, 226 or 228 and nail gun mounting support frame 140 is repositioned to the desired angle. In the arrangement shown, actuator 234 is positioned on a tilt handle 238 positioned above adjustable mounting plate 142 of nail gun assembly 16.

In the example arrangement shown, actuator 234 is a trigger type actuator. However, the embodiments are not so limited. Rather, it is contemplated that in one or more arrangements, tilt control assembly 144 may use various types of actuators including but not limited to, for example, triggers, levers, switches, sliders, buttons, pull chains, throttles, pedals, and/or any other type of method or means for actuating.

In the arrangement shown, tilt handle 238 is operably connected to adjustable mounting plate 142 by a handle support member 240 that extends upward from adjustable mounting plate 142 to tilt handle 238. In operation, tilt control assembly 144 allows the operator to set the position of nail gun assembly 16 by engaging and holding actuator 234, moving nail gun assembly 16 to the desired position via tilt handle 238, and then releasing actuator 234. During most operation, the vertical position will be selected. However, a user may set nail gun assembly 16 at an angled position to facilitate driving nails at an angle when nailing close to an edge of a floor panel as will be described below. Of course other tilting selections could be used to further customize to a particular application.

Nail Gun Tracking Wheels 146:

In one or more arrangements, a set of nail gun tracking wheels 146 are attached to the bottom of nail gun mounting support frame 140. Nail gun tracking wheels 146 are formed of any suitable size, shape, or design and are configured to facilitate movement of carriage assembly 14 in the linear direction 40. In the arrangement shown, as one example, nail gun tracking wheels 146 are similar to linear tracking wheels 34, having a generally circular disc shape with a cylindrical tube shaped collar 244 extending through a center of the nail gun tracking wheels 146. However, in the arrangement shown, nail gun tracking wheels 146 have angled portion 246 on the left and right side. This allows system 10 to continue to track true when nail gun 128 is tilted enabling nailing at an angle as discussed above.

### Recoil Assembly 22:

In one or more arrangements, nail gun assembly 16 is connected to frame 32 by a recoil assembly 22. Recoil assembly 22 is formed of any suitable size, shape, or design and is configured to facilitate recoil movement of nail gun assembly 16 when nails are driven to inhibit unintended movement of system and facilitate linear tracking of carriage assembly 14. In the arrangement shown, as one example, recoil assembly 22 includes a link member 252, a recoil spring 248, and a counterweight 250, among other components.

Link member 252 is formed of any suitable size, shape, or design and is configured to operably connect nail gun assembly 16 with frame 32 and facilitate recoil movement of nail gun assembly 16. In the arrangement shown, as one example, link member 252 has c-shape, when viewed from the top, formed by a front link 256, a rear link 258, and a crossbar 260 extending therebetween. In this example arrangement, front link 256 and rear link 258 each have an elongated generally rectangular planar shape extending between an upper edge 262 and lower edge 264 from a right end 266 to a left end 268. Front link 256 and rear link 258 each also have holes 270 positioned proximate to right end 266 and left end 268 to facilitate connection with nail gun assembly 16 and frame 32. In this example arrangement, crossbar 260 also has an elongated generally rectangular planar shape extending between upper edge 274 and lower edge 276 between left ends 268 of front link 256 and rear link 258.

In this example arrangement, link member 252 has a spring lever 278 extending upward from left end 268 of front link 256. Recoil assembly 22 is biased to move nail gun assembly 16 downward using a recoil spring 248. A first end or recoil spring 248 is attached to spring lever 278 of link member 252 and a second end of recoil spring 248 is attached to a recoil spring support 280, which is attached to frame 32. Recoil assembly 22 is able to rotate around carriage pivot bolts 218, which are connected to frame 32 at left ends 268 of front link 256 and rear link 258. This allows nail gun 128 to recoil without moving system 10 from the desired position.

### Counterweight 250:

In one or more arrangements, system 10 includes a counterweight 250 attached to the front of frame 32 to provide balance when nail gun 128 is fired and works in conjunction with recoil assembly 22 to prevent any shifting during operation. In the arrangement shown, counterweight 250 is attached to tab 84 of front flange 48 and tab 100 of rear flange 50. However, the embodiments are not so limited. Rather, it is contemplated that in one or more arrangements, counterweights may additionally or alternatively be placed at various other positions of system 10.

### Transverse Movement Assembly 24:

Transverse movement assembly 24 is formed of any suitable size, shape, or design and is configured to facilitate movement of system 10 in a transverse direction 288. In the arrangement shown, as one example, transverse movement assembly 24 includes a support frame 290 and a set of transverse tracking wheels 292, among other components.

### Support Frame 290:

Support frame 290 is formed of any suitable size, shape, or design and is configured to operably connect transverse tracking wheels 292 with frame 32 of carriage assembly 14 so that carriage assembly 14 may lifted off of the floor and supported by transverse tracking wheels 292 so as to permit a user to move system 10 in transverse direction 288. In the arrangement shown, as one example, support frame 290 has a back member 296 operably connected to rear flange 50 of frame 32 by a set of three support brackets 298.

### Back Member 296:

In this example arrangement, back member 296 has a generally rectangular planar shape, when viewed from the back, extending between an upper edge 302, a lower edge 304, and opposing side edges 306.

### Support Brackets 298:

In this example arrangement, support brackets 298 each have a generally rectangular shape, when viewed from the side, extending between an upper edge 310, a lower edge 312, a front edge 314, and a rear edge 316. In the arrangement shown, support brackets have flanges 318 extending to the side from front edges 314 of support brackets 298. In this example arrangement, flanges 318 have holes 320 to facilitate connection with rear flange 50 of frame 32 (e.g., using bolts). In this example arrangement, rear edge 316 of two of the support brackets 298 are positioned at and attached to opposing side edges 306 of back member 296 of transverse movement assembly 24. In this example arrangement, the third support bracket 298 is positioned between the other two support brackets at approximately middle of the back member 196. In this example arrangement, support brackets 298 are connected to back member 196 by welding. However, the arrangements are not so limited. Rather, it is contemplated that components of support brackets 298 may be connected to one another or back member 196 using various means and methods known in the art including but not limited to, for example, adhesive bonding, chemical bonding, welding, and/or mechanical attachment means such as screws, bolts, threading, interlocks, clips, pins, or other coupling devices.

### Transverse Tracking Wheels 292:

In the example arrangement shown, transverse movement assembly 24 includes two transverse tracking wheels 292 connected to a forward side of back member 196. In this example arrangement, transverse tracking wheels 292 are similar if not identical to linear tracking wheels 34. In this example arrangement, transverse tracking wheels 292 are located at a position on back member 196 so that transverse tracking wheels 292 extend below lower edge 304 of back member 296 but do not engage the floor when all linear tracking wheels 34 are in contact with the floor. In one or more arrangements, transverse movement assembly 24 positions transverse tracking wheels 292 at an angle, so that transverse tracking wheels 292 are positioned vertically and track straight when system 10 is tilted onto transverse tracking wheels 292 for transverse movement. In this example arrangement, when system 10 is tilted onto transverse tracking wheels 292 and linear tracking wheels 34 are raised off the flooring, user may move system 10 in a transverse direction 288 to reposition system 10.

Although system 10 may be primarily described in some arrangements with reference to a transverse movement assembly 24 that facilitates movement in transverse direction 288 by tilting system up on to transverse tracking wheels 292, the embodiments are not so limited. Rather, it is contemplated that in one or more arrangements, transverse movement assembly 24 may facilitate movement in transverse direction 288 without tilting system 10. For example, in one or more arrangements, transverse movement assembly 24 may include a set of wheels that are configured to be lowered and the thereby lift system 10 and linear tracking wheels 34 off of the flooring, thereby permitting system to be moved in the transverse direction 288.

Furthermore, although transverse movement assembly 24 and carriage assembly 14 may be described as a separate components with reference to some arrangements, the embodiments are not so limited. Rather, it is contemplated that in one or more arrangements, transverse movement assembly 24 and carriage assembly 14 may be implemented together as a moveable platform able to selectably move linearly forward and backward, as well as transversely from side to side.

### Handle Assembly 26:

Handle assembly 26 is formed of any suitable size, shape, or design and is configured to facilitate linear and transverse movement of system 10 by a user and facilitate operation of nail gun 128 by the user. In the arrangement shown, as one example, handle assembly 26 includes a handle 328 and a control assembly 330 mounted on handle 328, among other components.

### Handle 328:

Handle 328 is formed of any suitable size, shape, or design and is configured to operably connect with carriage assembly 14 and/or transverse movement assembly 24 and extends upwards to a level that allows the user to stand while operating system 10. In the arrangement shown, handle 328 is formed by a pair of metal tube segments 332. In this example arrangement, when joined together the metal tube segments 332 form an elongated generally rectangular loop. In this example arrangement, each of the tube segments 332 includes a lower crossbar 336, an angled sidebar 338, and an upper crossbar 340. In this example arrangement, lower crossbar 336 has generally elongated tube shape extending between opposing ends 344. In this example arrangement, the outward end of lower crossbar 336 includes a upward and rearward bend 346. In this example arrangement, sidebars 338 each have an elongated tube shape extending from lower end 350 to a upper end 352. Lower ends 350 of side bars 338 are connected to an end 344 of lower crossbar 336 that is bent upward and rearward by bend 346. In this example arrangement, upper crossbar 340 has generally elongated tube shape extending between opposing ends 354. In this example arrangement, the outward end of upper crossbar 340 includes a downward and forward bend 356. In this example arrangement, upper ends 352 of side bars 338 are connected to an end 354 of upper crossbar 340 that is bent downward and forward by bend 356.

In the arrangement shown, handle 328 is operably connected to frame 32 by two handle clamps 360 connected with two of the support brackets 298. Handle clamps 360 are formed of any suitable size, shape, or design and are configured to engage and clamp onto lower crossbars 336 of a tube segments 332. In the arrangement shown, as one example, handle clamps 360 are formed by an upward facing cylindrical recess 362 in upper edge 310 of the two support brackets 298 and a bracket 364 having a downward facing cylindrical recess 366. In this example arrangement, brackets 364 are attached to support brackets by bolts 368 that extend through holes in brackets and into support brackets 298. As bolts 368 are tightened, lower crossbars 336 are clamped between upward facing recess 362 and downward facing recess 366, thereby operably connecting handle to transverse movement assembly 24 and carriage assembly 14.

### Control Assembly 330:

In the arrangement shown, control assembly 330 is attached to and connect upper crossbars 340 of segments 332 of handle assembly 26. Control assembly 330 is formed of any suitable size, shape, or design and is configured to attach to and connect upper crossbars 340 of segments 332 of handle assembly 26 and facilitate user control of and operation of nail gun 128. In the arrangement shown, control assembly includes a set of controls 372 positioned within or connected to a housing 370, among other components.

In the arrangement shown, housing 370 has a generally rectangular block shape formed by a top half 376 and a bottom half 378. In this example arrangement, bottom half 378 has a upward facing cylindrical recess 380 formed in an upper surface of the bottom half 378. Conversely in this example, top half 376 has a downward facing cylindrical recess 382 formed in an bottom surface of the top half 376. In this example arrangement, top half 376 and bottom half 378 are connected together by bolts 384 that extend through holes top half 376 and bottom half 378. As bolts 368 are tightened, upper crossbars 340 are clamped between the upward facing cylindrical recess 380 downward facing cylindrical recess 382, thereby connecting control assembly 330 to handle 328.

In one or more arrangements, the set of controls 372 of the control assembly 330 include a safety interlock arrangement configured to prevent accidental firing of nail gun 128. In the embodiment shown, set of controls 372 uses actuator safety interlock lines 390 and a remote actuator line 392. Remote actuator line 392 is attached to trigger control 388 of nail gun 128 in place of a manual trigger to pneumatically control the firing of nail gun 128. In the embodiment shown, the set of controls includes two actuators 394 that must be engaged before nail gun 128 will fire. In the example arrangement shown, actuators 394 are trigger switches that must be depressed before nail gun 128 will fire.

However, the embodiments are not so limited. Rather, it is contemplated that in one or more arrangements, the set of controls 372 may use various types of actuators including but not limited to, for example, triggers, levers, switches, sliders, buttons, pull chains, throttles, pedals, and/or any other type of method or means for actuating.

Furthermore, it is also contemplated that in some arrangements, other safety mechanisms could be additionally or alternatively be used to ensure safe operation and to prevent misfires such as, but not limited to optical, electronic or physical controls as is known in the art. In the embodiment shown, the factory equipped nail gun trigger (not shown) is removed and a pneumatic trigger control is connected to allow remote firing of nail gun 128. Again, other remote firing mechanisms could be used as long as the user is able to engage the nail gun 128 remotely.

### Pressure Control System 400:

In one or more arrangements, system 10 includes a pressure control system 400 for use with a pneumatically-driven-type nail gun 128. Pressure control system 400 is formed of any suitable size, shape, or design and is configured to supply and regulate air pressure provided to nail gun 128 from an air compressor (not shown). In an arrangement shown, as one example, pressure control system 400 includes a set of reservoir tanks 402, a manifold 404, and air hoses 406, among other components. In this example arrangement, pressure control system 400 includes two reservoir tanks 402 connected to manifold 404. In this example arrangement, manifold 404 fluidically connects reservoir tanks 402 to air compressor and nail gun 128 via air hoses 406. The reservoir tanks 402 help to maintain pressure following the sudden discharge of pressure by nail gun when nails are driven and permit a user to drive nails quickly in succession without needing to wait for air compressor to restore sufficient air pressure. This configuration with reservoir tanks 402 holding relatively large volumes of pressurized air help to facilitate very consistent depth of drive of nails. This is particularly true when driving multiple nails in rapid succession. The results reveal that nails driven in rapid succession are driven to consistent depths, which is a substantial improvement over the prior art when an air hose 406 is connected directly to a conventional nailer. In one or more arrangements, pressure control system 400 may optionally include a regulator 408 and/or pressure gauge 410 to permit a user to adjust the amount of pressure provided to nail gun 128 to operate system 10.

In Operation:

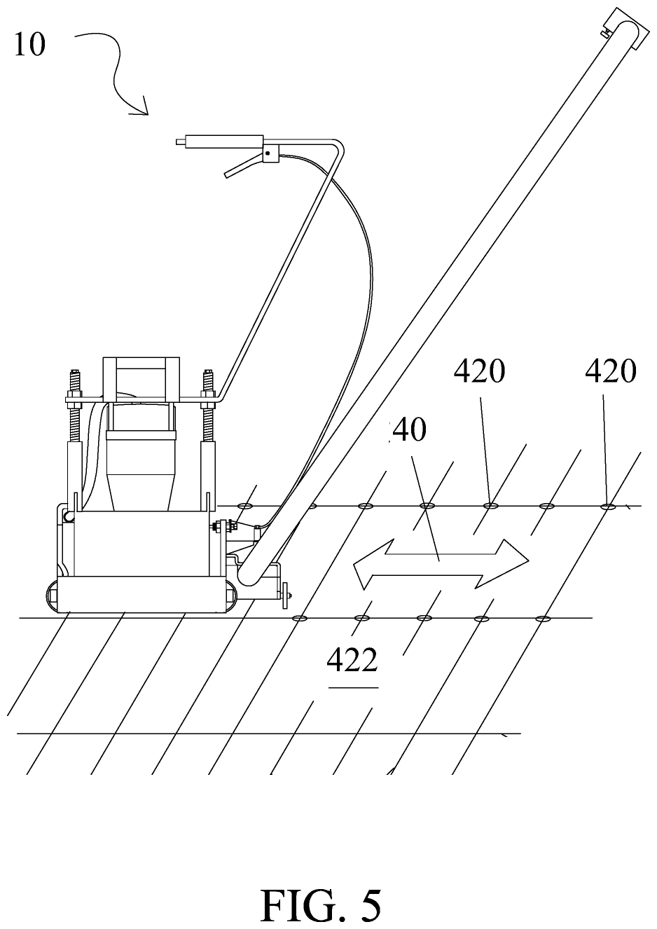

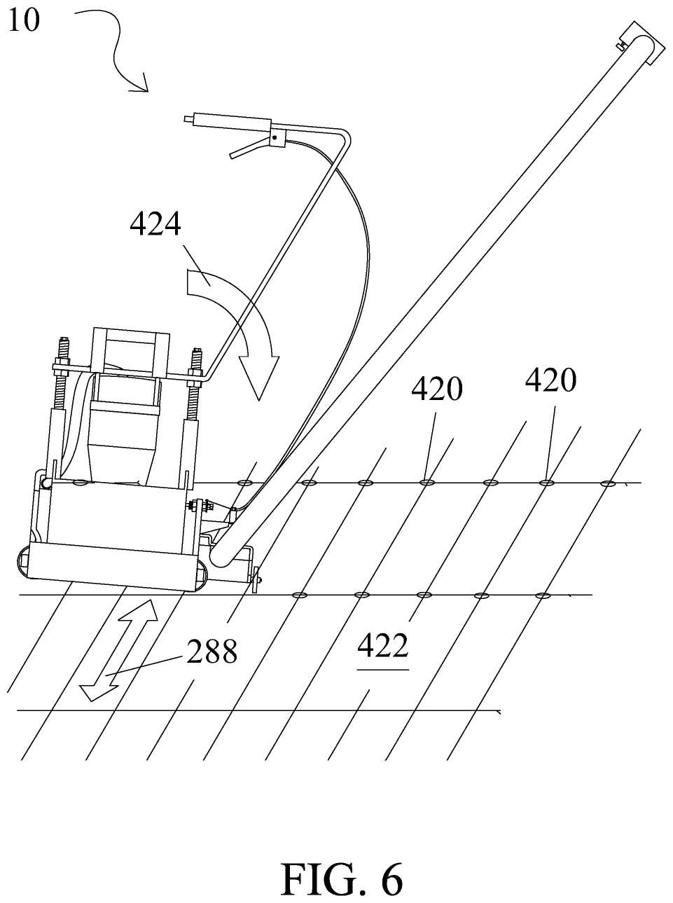

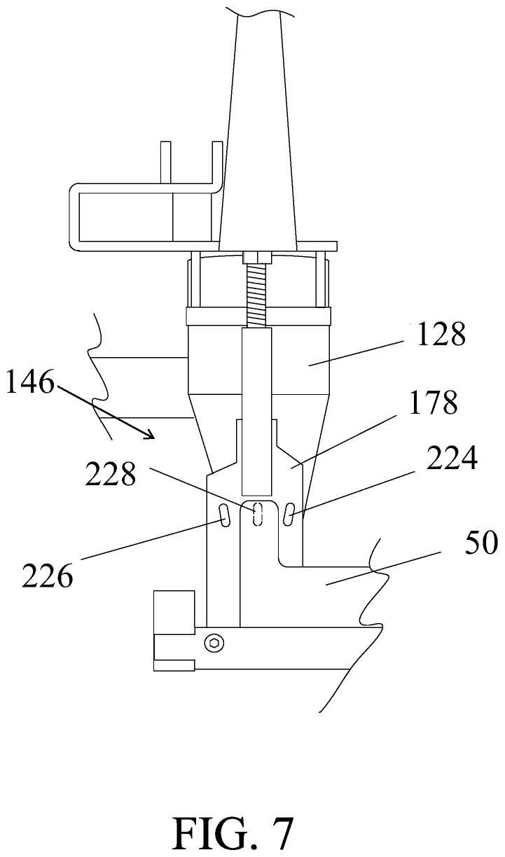

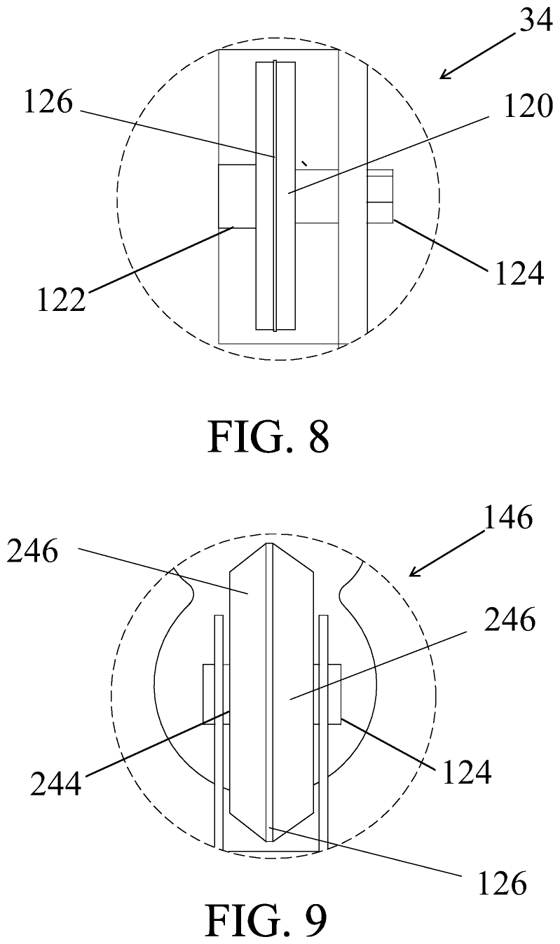

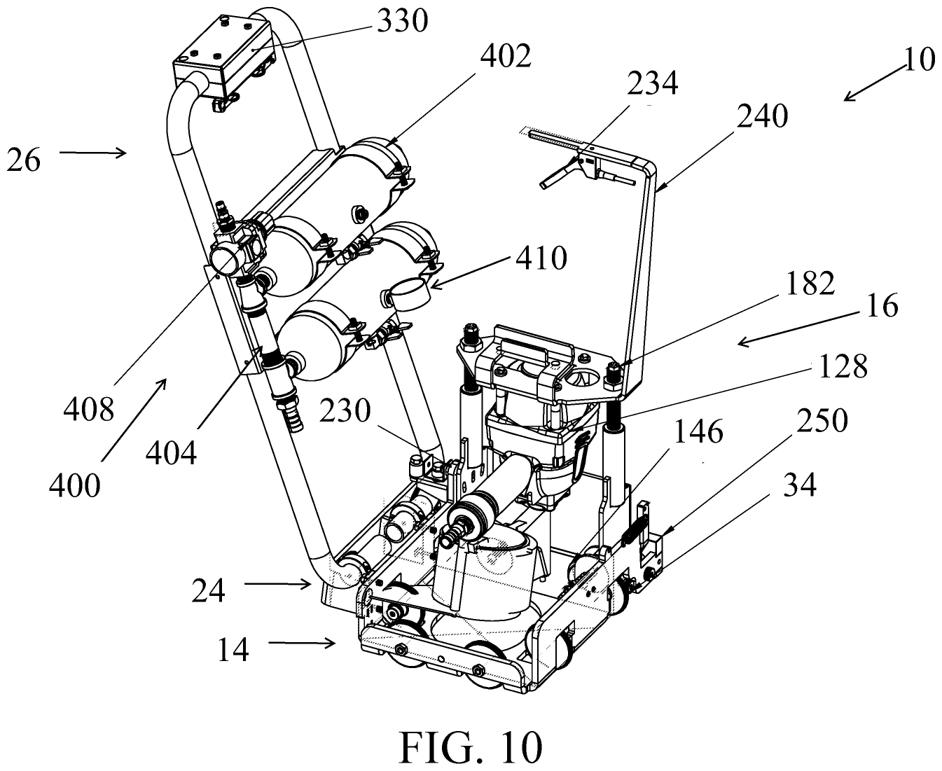

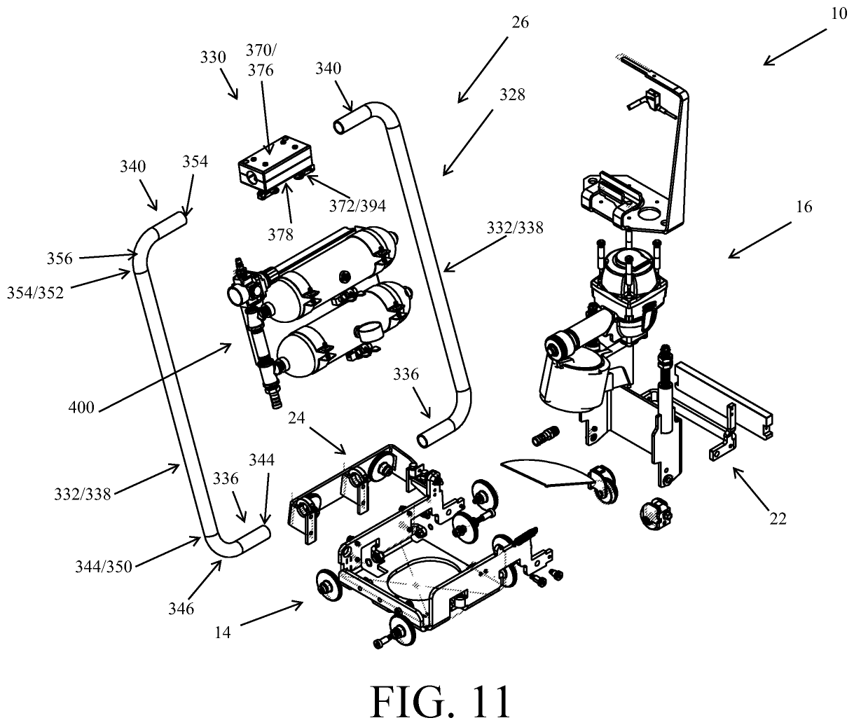

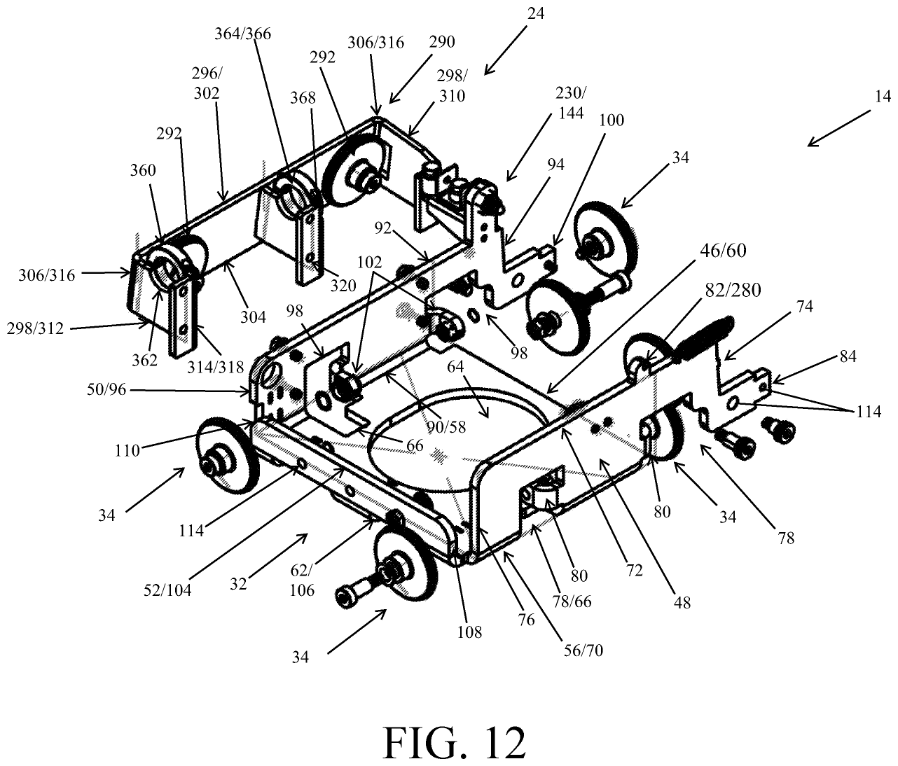

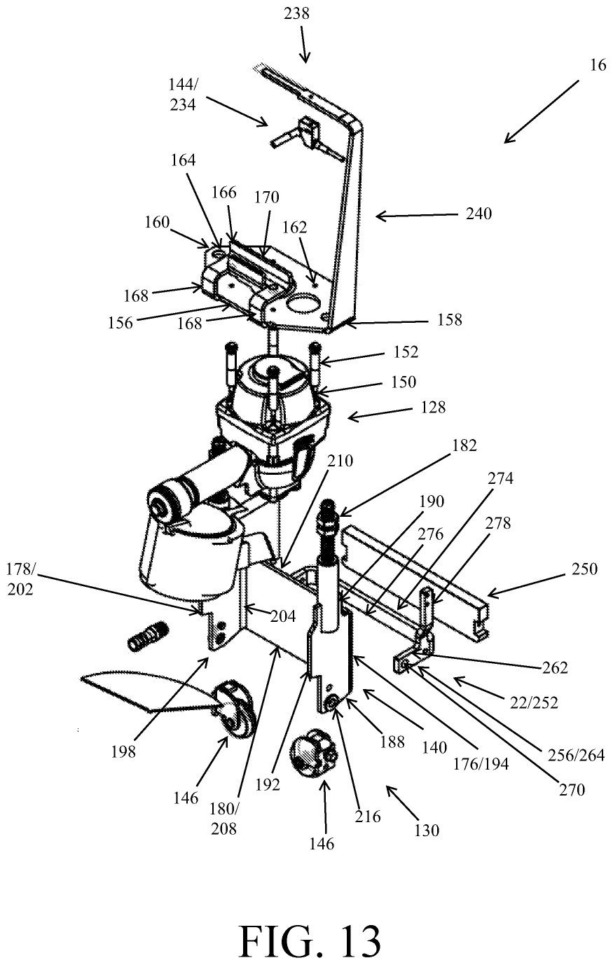

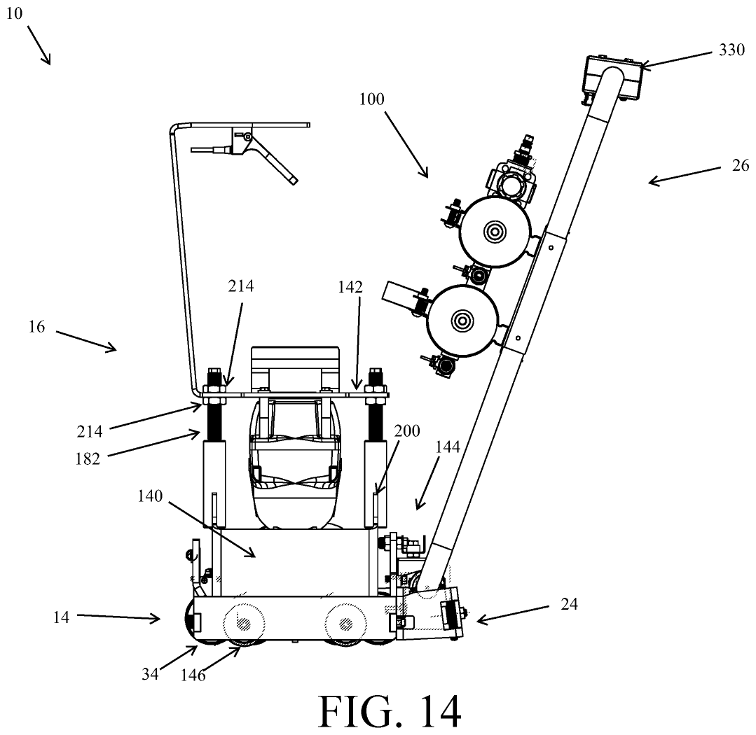

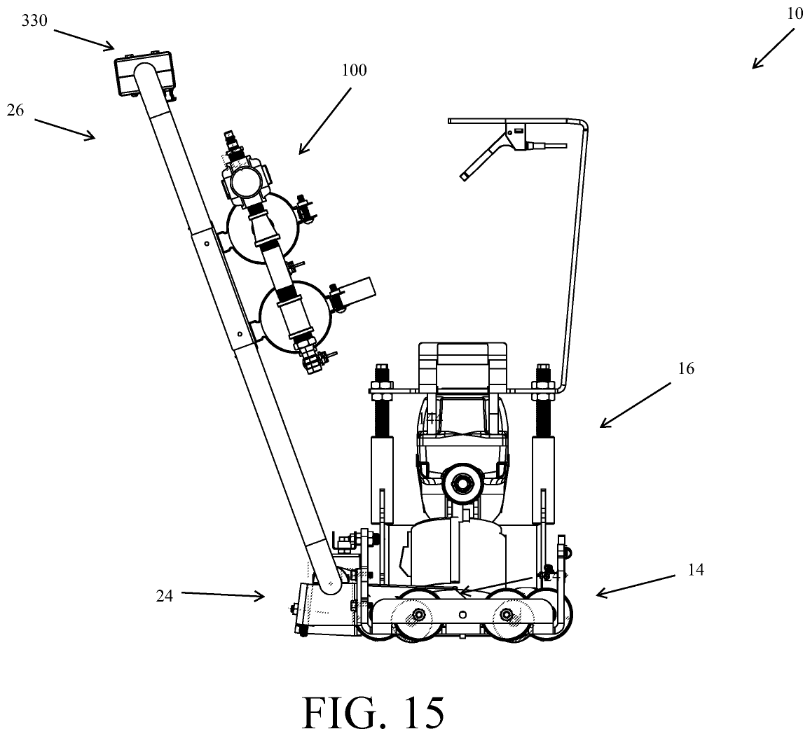

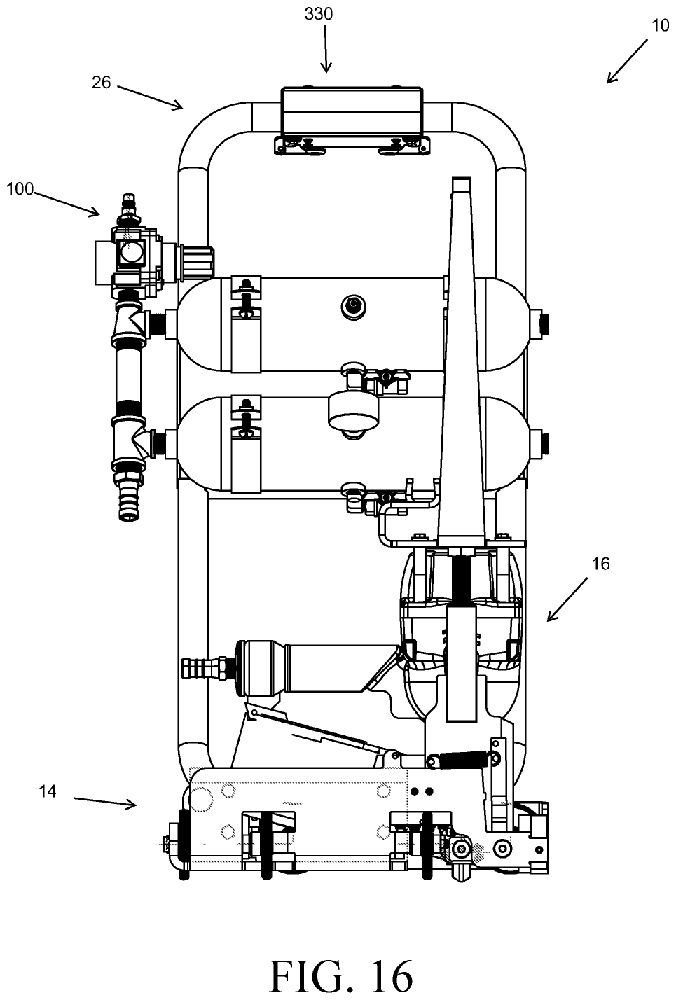

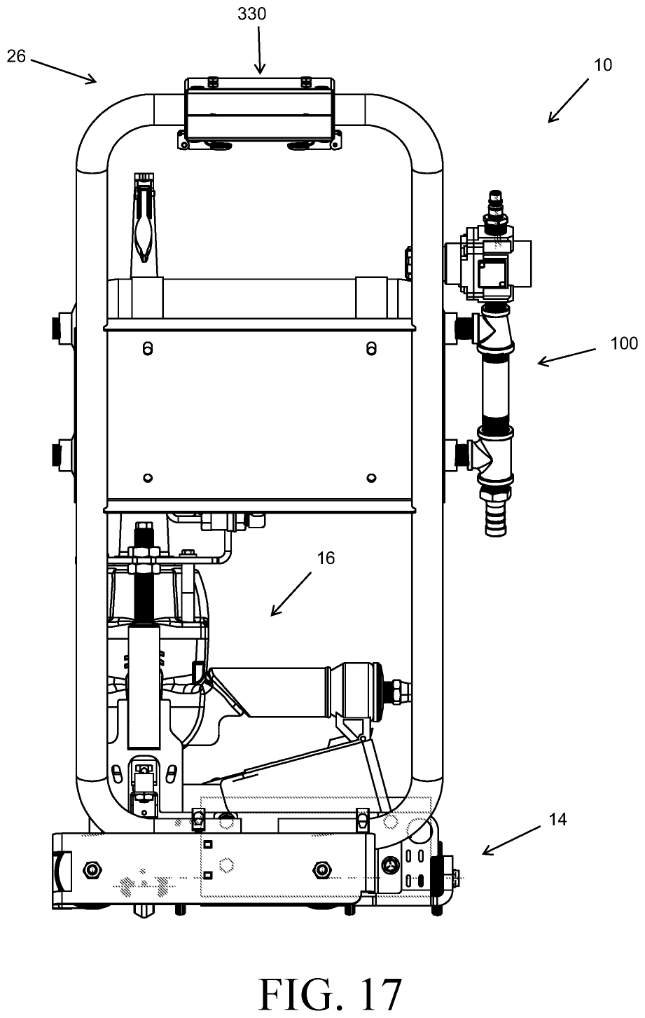

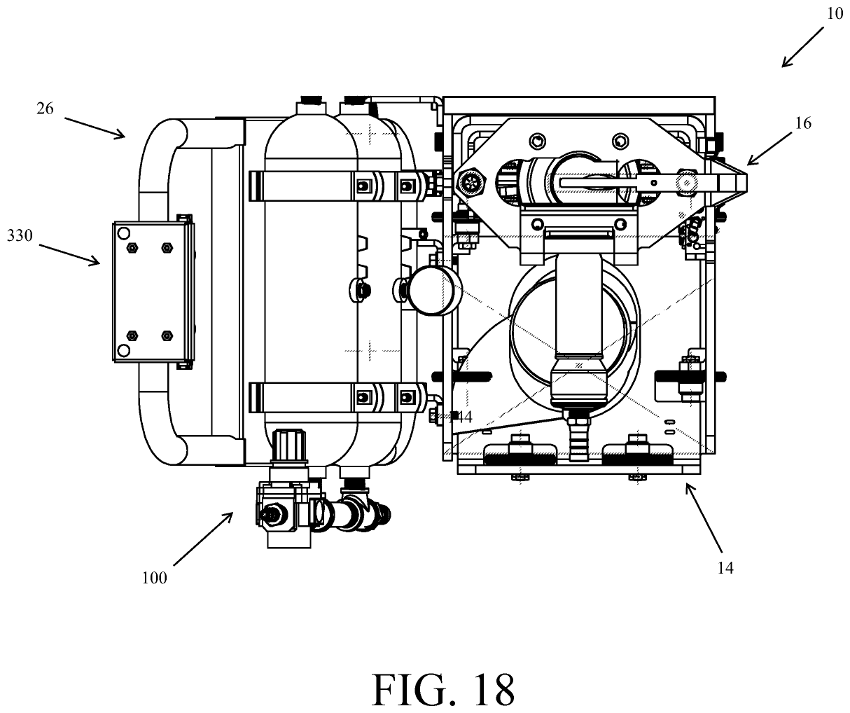

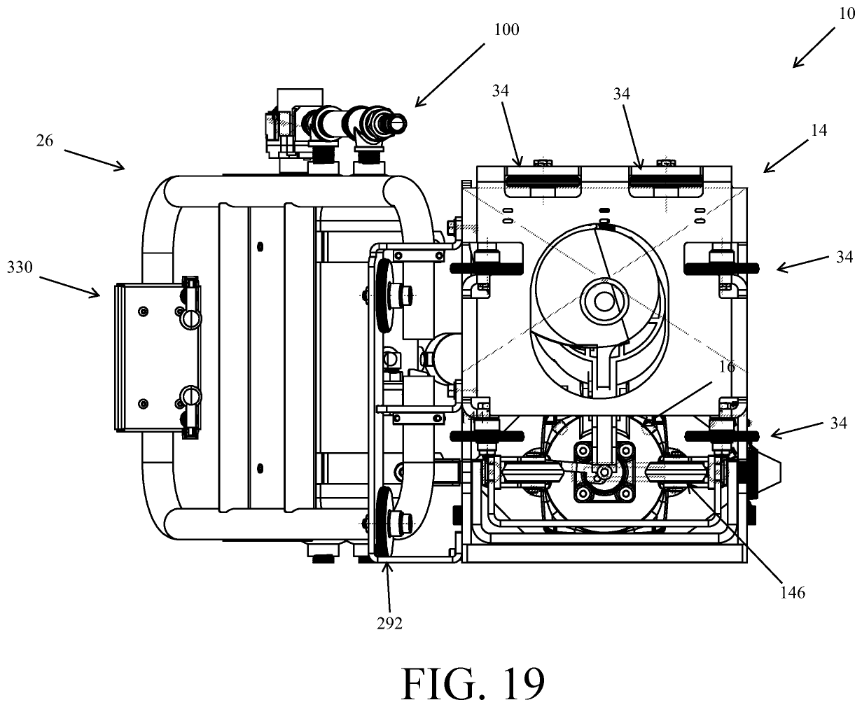

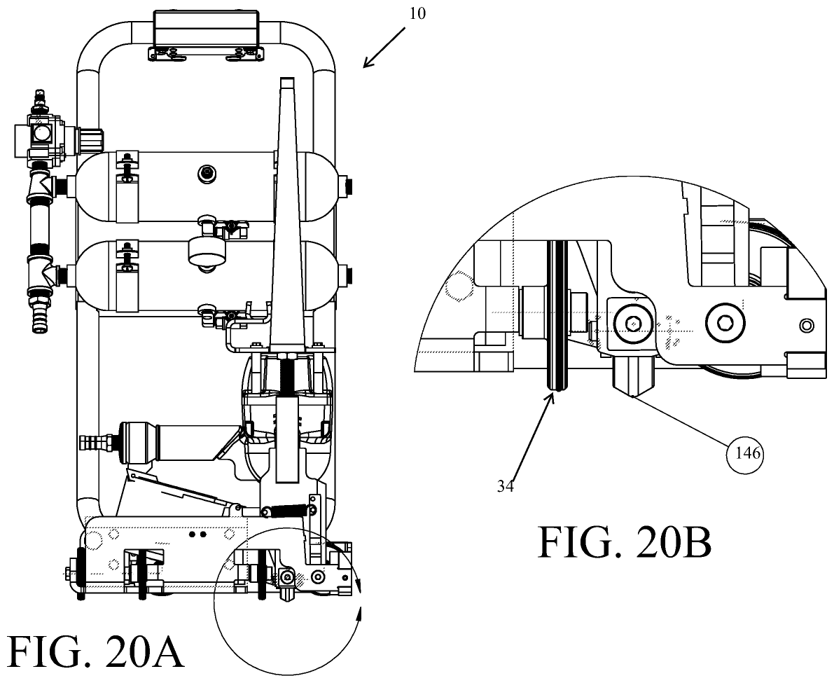

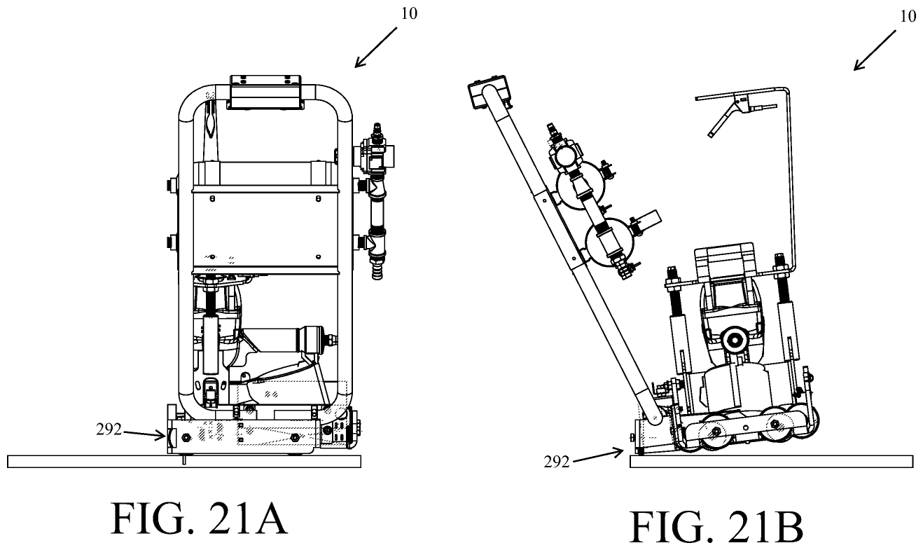

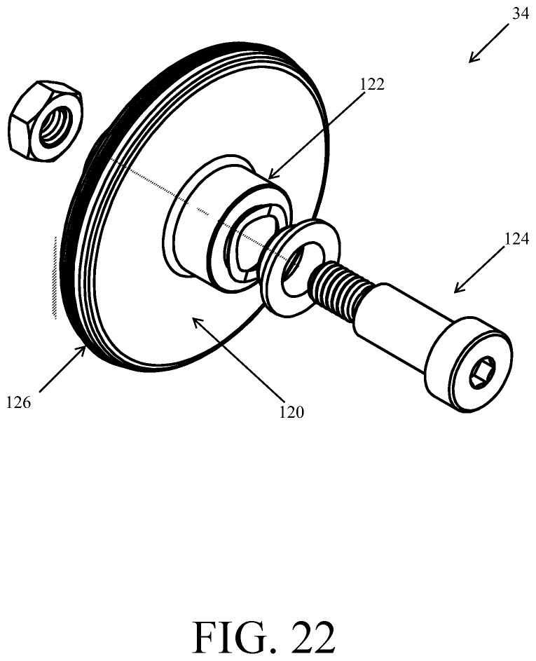

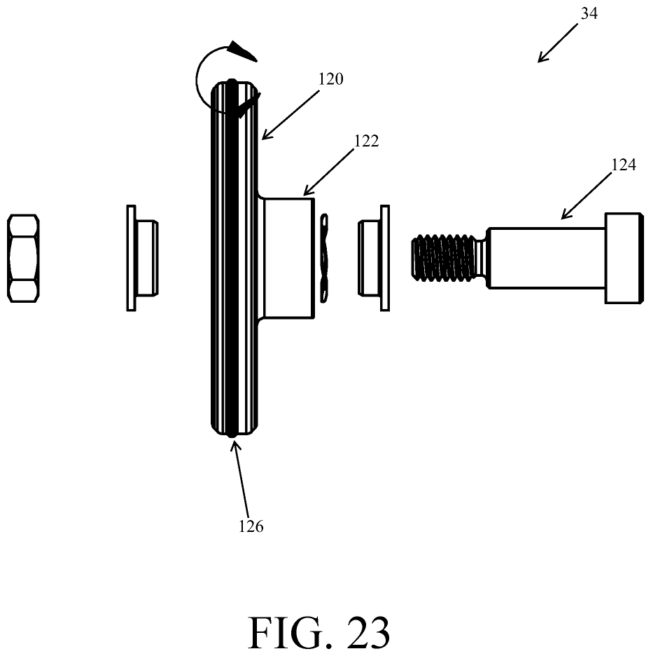

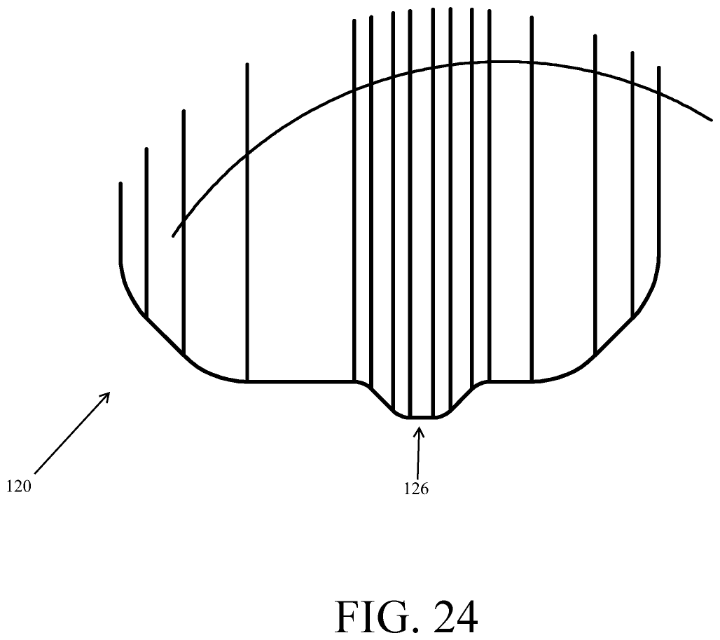

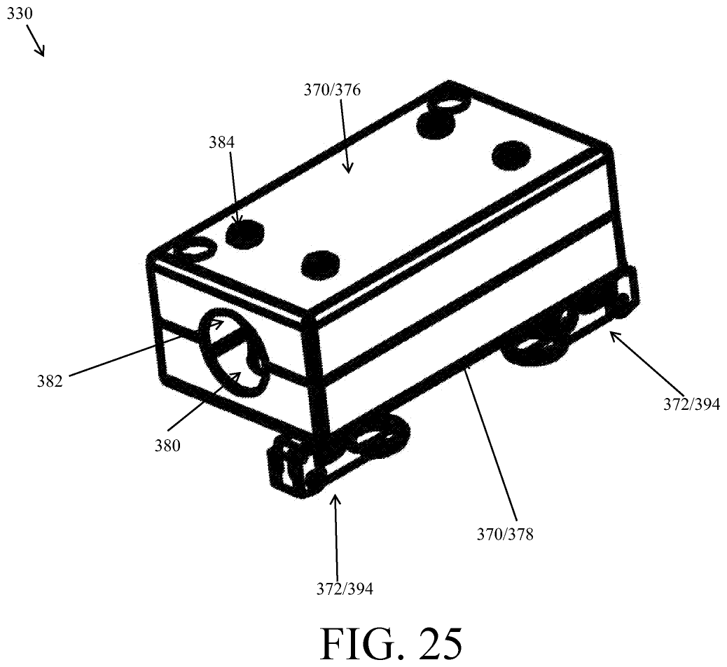

Now referring to FIGS. 5 and 6, during operation, the user positions system 10 on a panel 422 to be nailed. When resting on panel 422 in a normal position, system 10 will naturally track linearly along panel 422 and the user depresses safety trigger switches 394 and this fires nail gun 128 driving a nail 420 into panel 422. The user pushes or pulls system 10 linearly in forward/backward direction 40 to drive nails 420 as desired. When a linear row is complete, the user tilts system 10 rearward onto transverse wheels 292 (e.g., by moving an upper end of handle 328 downward and rearward), which lifts frame 32 off panel 422 in a rotational motion 424 and the user moves system 10 in a transverse direction 288 from linear movement 40 and returns system 10 to a level position resting once again on all six linear tracking wheels 34 to continue nailing in linear direction 40. The process is repeated as needed.

The tilt function of nail gun assembly 16 of system 10 comes into play when the user needs to nail around the edges of panels 422, where panels meet each other and where there is limited space to nail such as when nailing over a floor joist which measure nominally 1½ inches. In this case, the user uses actuator 234 to set the angle of nail gun 128 so as to secure the two panels together. Nail gun 128 can be angled in either direction so that both sides of the panel may be secured using this method.

### Not Limited to Installation of Flooring:

Although some arrangement may be primarily described in the context of driving nails to facilitate the installation of flooring, the embodiments are not so limited. Rather, it is contemplated that in various different arrangements, system 10 may be configured to drive various suitable fasteners to facilitate installation of various different building materials. As one example, if is contemplated that system may be useful to facilitate installation of drywall, panels, sheets, or another material and a pre-framed wall prior to erecting the wall in place. For example a pre-framed wall may be laid horizontally in a suitable sized area and wall panel placed on the studs. In this position the panel may be attached to studs of the wall using system 10 in a manner very similar to the way that flooring is installed and attached to floor joists. After panels have been attached, the wall may be erected, moved into location, and attached in placed.

From the above discussion it will be appreciated that the disclosed platform and system improves upon the state of the art. That is, in one or more arrangements, an ergonomic nail gun platform and system is presented: that improves upon the state of the art; that is easy to use; that is fast and efficient to use; that is portable; that is cost effective; that drives nails vertically and at an angle; that can be moved linearly forward and backward as well as transversely to the side; that can be moved and operated from a standing position; that has a durable design; that has a long useful life; that has a wide variety of applications; and/or that improves the ergonomics of use among countless other advantages, improvements and features.

It will be appreciated by those skilled in the art that other various modifications could be made to the device without parting from the spirit and scope of this invention. All such modifications and changes fall within the scope of the claims and are intended to be covered thereby.

What is claimed is:

1. A system for driving nails, comprising:
a carriage assembly;
a nail gun assembly operably connected to the carriage assembly;
wherein the nail gun assembly is configured to drive nails into a floor to facilitate installation of flooring;
wherein the carriage assembly is configured to guide the system in a linear direction on the floor to facilitate driving of the nails into the floor along a straight line;
wherein the nail gun assembly is movable between a plurality of positions including a tilted position and a non-tilted position;
wherein when in the non-tilted position, the nail gun assembly is configured to drive the nails into the floor at a generally perpendicular angle to the flooring;
wherein when in the tilted position, the nail gun assembly is configured to drive the nails into the floor at an angle to facilitate angled nailing of the flooring.

2. The system of claim 1, further comprising a tilt control assembly;
the tilt control assembly including an actuator;
the actuator configured to be movable between a first position and a second position;
wherein when the actuator is in the first position, the tilt control assembly is configured to hold the nail gun assembly at one of the plurality of positions;
wherein when the actuator is in the second position, the tilt control assembly is configured to permit the nail gun assembly to be moved between the plurality of positions.

3. The system of claim 1, further comprising a tilt control assembly;
the tilt control assembly including an actuator;
the actuator configured to be movable between a first position and a second position;
wherein when the actuator is in the first position, the tilt control assembly is configured to hold the nail gun assembly at one of the plurality of positions;
wherein when the actuator is in the second position, the tilt control assembly is configured to permit the nail gun assembly to be moved between the plurality of positions;
wherein the actuator is connected to a handle connected to the tilt control assembly;
wherein movement of the handle by a user moves the nail gun assembly.

4. The system of claim 1, wherein when in the non-tilted position, the nail gun assembly is configured to drive the nails into the floor approximately vertically.

5. The system of claim 1, wherein the plurality of positions include the tilted position, the non-tilted, and a second tilted position.

6. The system of claim 1, further comprising:
a handle operably connected to the carriage assembly;
the handle configured to facilitate movement and operation of the system by a user in a standing position;
a control assembly operably connected to an upper end of the handle;
wherein the control assembly is configured to trigger nailing of the nails by the nail gun assembly.

7. The system of claim 1, further comprising:
a handle operably connected to the carriage assembly;
the handle configured to facilitate movement and operation of the system by a user in a standing position;
a control assembly operably connected to an upper end of the handle;
wherein the control assembly is configured to trigger nailing of the nails by the nail gun assembly;
wherein the control assembly includes a first switch and a second switch;
wherein the control assembly is configured to only trigger nailing of the nails by the nail gun assembly when both the first switch and the second switch are engaged by a user.

8. The system of claim 1, further comprising a recoil assembly;
wherein the recoil assembly operably connects the nail gun assembly to the carriage assembly;
wherein the recoil assembly is configured to permit nail gun assembly to recoil when one or the nails is driven to inhibit unintended movement of system.

9. The system of claim 1, further comprising an air tank reservoir;
wherein the nail gun assembly includes a pneumatic nail gun powered by an air compressor;
wherein the air tank reservoir is fluidically connected to the pneumatic nail gun and to the compressor;
wherein the air tank reservoir mitigates drops in pressure when the pneumatic nail gun drives nails.

10. The system of claim 1, further comprising a transverse movement assembly;
wherein the transverse movement assembly is configured to guide system in a direction transverse to the linear direction when system is tilted backward to an angle by a user.

11. The system of claim 1, wherein the nail gun assembly includes a nail gun mounting support frame;
wherein the nail gun mounting support frame is configured to permit mounting of a plurality of different commercial off the shelf nail guns.

12. The system of claim 1, wherein the carriage assembly includes a set of wheels configured to facilitate movement of the carriage assembly in the linear direction; and
wherein the set of wheels have a ridge protruding outward from the set of wheels and extending around a circumference of the set of wheels.

13. The system of claim 1, wherein the nail gun assembly includes a set of wheels operably connected to a lower end of the nail gun assembly;
wherein the set of wheels are configured to facilitate movement of the carriage assembly in the linear direction;
wherein an outer circumference of the set of wheels has a flat portion and an angled portion;
wherein when the nail gun assembly is in the non-tilted position, the flat portion is configured to engage the floor and facilitate movement of the system in a straight line in the linear direction;
wherein when the nail gun assembly is in the tilted position, the angled portion is configured to engage the floor and facilitate movement of the system in the straight line in the linear direction.

14. A system for driving nails, comprising:
a carriage assembly;
a nail gun assembly operably connected to the carriage assembly;
wherein the nail gun assembly is configured to drive nails into a floor to facilitate installation of flooring;
wherein the carriage assembly includes a first set of wheels configured to guide the system in a first direction on the floor to facilitate driving of the nails along a straight line;
a transverse movement assembly;
the transverse movement assembly including a second set of wheels configured to guide the system in a second direction that is transverse to the first direction;
wherein the transverse movement assembly is movable between a first orientation and a second orientation;
wherein when the transverse movement assembly is in the first orientation, the first set of wheels are placed in contact with the floor and the second set of wheels are raised above the floor, thereby permitting movement of the system in the first direction;
wherein when the transverse movement assembly is in the second orientation, the second set of wheels are placed in contact with the floor and the first set of wheels are raised above the floor, thereby permitting movement of the system in the second direction.

15. The system of claim 14, wherein the first direction is perpendicular to the second direction.

16. The system of claim 14, wherein when the transverse movement assembly is in the second orientation, the system is tilted backward at an angle onto the second set of wheels.

17. The system of claim 14, further comprising a handle operably connected to the carriage assembly;
the handle configured to facilitate movement and operation of the system by a user in a standing position;
wherein moving an upper end of the handle downward and rearward by the user causes the transverse movement assembly to be placed in the second orientation, thereby permitting movement of the system in the second direction.

18. The system of claim 14, further comprising:
a handle operably connected to the carriage assembly;
a control assembly operably connected to an upper end of the handle;
the handle configured to facilitate movement and operation of the system by a user in a standing position;
wherein moving the upper end of the handle downward and rearward by the user causes the transverse movement assembly to be placed in the second orientation, thereby permitting movement of the system in the second direction;
wherein the control assembly is configured to trigger nailing of the nails by the nail gun assembly.

19. The system of claim 14, further comprising:
a handle operably connected to the carriage assembly;
a control assembly operably connected to an upper end of the handle;
the handle configured to facilitate movement and operation of the system by a user in a standing position;
wherein moving the upper end of the handle downward and rearward by the user causes the transverse movement assembly to be placed in the second orientation, thereby permitting movement of the system in the second direction;
wherein the control assembly is configured to trigger nailing of the nails by the nail gun assembly;
wherein the control assembly includes a first switch and a second switch;
wherein the control assembly is configured to only trigger nailing of the nails by the nail gun assembly when both the first switch and the second switch are engaged by the user.

20. The system of claim 14, wherein the nail gun assembly is movable between a plurality of positions including a tilted position and a non-tilted position;
wherein when in the tilted position, the nail gun assembly is configured to drive the nails into the floor at an angle to facilitate angled nailing of the flooring.

21. The system of claim 14, wherein the nail gun assembly is movable between a plurality of positions including a first tilted position, a second tilted position, and a non-tilted position;
wherein when in the first tilted position, the nail gun assembly is configured to drive the nails into the floor at a first angle to facilitate angled nailing of the flooring;
wherein when in the second tilted position, the nail gun assembly is configured to drive nails into the floor at a second angle to facilitate angled nailing of the flooring.

22. The system of claim 14, wherein the nail gun assembly is movable between a plurality of positions including a tilted position and a non-tilted position;
wherein when in the tilted position, the nail gun assembly is configured to drive nails into the floor at an angle to facilitate angle-nailing of the flooring;
wherein the system further comprising a tilt control assembly;
the tilt control assembly including an actuator;
the actuator configured to be movable between a first position and a second position;
wherein when the actuator is in the first position, the tilt control assembly is configured to hold the nail gun assembly at one of the plurality of positions;
wherein when the actuator is in the second position, the tilt control assembly is configured to permit the nail gun assembly to be moved between the plurality of positions.

23. The system of claim 14, further comprising a recoil assembly;
wherein the recoil assembly operably connects the nail gun assembly to the carriage assembly;
wherein the recoil assembly is configured to permit the nail gun assembly to recoil when one of the nails is driven to inhibit unintended movement of system.

24. The system of claim 14, further comprising an air tank reservoir;
wherein the nail gun assembly includes a pneumatic nail gun powered by an air compressor;
wherein the air tank reservoir is fluidically connected to the pneumatic nail gun and to the compressor.

25. The system of claim 14, wherein the nail gun assembly includes a nail gun mounting support frame;
the nail gun mounting support frame configured to permit mounting of a plurality of different commercial off the shelf nail guns.

26. A system for driving nails, comprising:
a carriage assembly;
a nail gun assembly operably connected to the carriage assembly;
wherein the nail gun assembly includes a pneumatic nail gun configured to drive nails into a floor to facilitate installation of flooring;
wherein the carriage assembly includes a first set of wheels configured to guide the system in a first direction on the floor to facilitate driving of the nails along a straight line;
an air pressure regulation system;
wherein the air pressure regulation system includes an air tank reservoir fluidically connected to the pneumatic nail gun;
wherein the air tank reservoir is configured to be fluidically connected to an air compressor;
wherein the air tank reservoir is configured to be pressurized by the air compressor;
wherein the air tank reservoir is configured to reduce variation in air pressure provided to the pneumatic nail gun during use.

27. The system of claim 26, wherein the air pressure regulation system is configured to regulate air pressure that is provided to the pneumatic nail gun.

28. The system of claim 26, wherein the air tank reservoir is pressurized to a first level of pressure;
wherein the air pressure regulation system is configured to provide a second level of pressure to the pneumatic nail gun;
wherein the second level of pressure is less than the first level of pressure.

29. The system of claim 26, further comprising a transverse movement assembly;
the transverse movement assembly including a second set of wheels;
wherein the second set of wheels is configured to guide the system in a second direction that is transverse to the first direction.

30. The system of claim 26, wherein the nail gun assembly is movable between a plurality of positions including a tilted position and a non-tilted position;
wherein when in the tilted position, the nail gun assembly is configured to drive the nails into the floor at an angle to facilitate angle-nailing of the flooring.
